(19) United States
(12) Patent Application Publication
(10) Pub. No.: US 2026/0353099 A1
(43) Pub. Date: Nov. 5, 2026

(54) RADIO ZONE DESIGN APPARATUS, AND PROGRAM

(71) Applicant: NTT, INC., Tokyo (JP)

(72) Inventors: Daisuke MURAYAMA, Tokyo (JP); Toshiro NAKAHIRA, Tokyo (JP); So TAKATANI, Tokyo (JP); Takatsune MORIYAMA, Tokyo (JP)

(21) Appl. No.: 19/124,629

(22) PCT Filed: Nov. 9, 2022
(86) PCT No.: PCT/JP2022/041762

§ 371 Date: Apr. 25, 2025

(51) Int. Cl. H04W 16/18; H04B 17/20; H04B 17/309

(52) U.S. Cl. CPC H04W 16/18; H04B 17/202; H04B 17/309

(57) ABSTRACT

An object of the present disclosure is to appropriately design installation of a base station for wireless communication.

Therefore, a radio zone design apparatus according to the present disclosure, by performing radio wave propagation estimation for each evaluation position where a radio wave can be received from each base station related to each combination of an antenna of a predetermined type or an access point device of a predetermined type in a case where installation is performed at a predetermined installation position candidate in a predetermined installation orientation by radio wave propagation estimation, calculates an estimated reception power at each evaluation position for each combination; calculates a quality evaluation index indicating a ratio of a number of predetermined evaluation positions where a target reception power is achieved to a number of all evaluation positions in each combination; calculates a cost evaluation index in each combination on a basis of cost information of each base station; calculates a comprehensive evaluation index in each combination on a basis of the quality evaluation index and the cost evaluation index; and selects, from each combination, for example, a combination that is single in which a comprehensive evaluation index having a maximum value is calculated.

### TECHNICAL FIELD

The present disclosure relates to a technology for estimating a position or the like where a base station for wireless communication is installed.

### BACKGROUND ART

In general, in a case where a base station for wireless communication such as 5th generation (5G) or Wi-Fi is installed, it is necessary to consider an installation position and an installation orientation in consideration of a radio wave shielding object such as a structure (Non Patent Literature 1).

### CITATION LIST

### Non Patent Literature

Non Patent Literature 1: NTT DoCoMo Technical Journal vol. 2 no. 4

<https://www.nttdocomo.co.jp/binary/pdf/corporate/technology/rd/technical_journal/bn/vol2_4/vol2_4_035jp.pdf>

### SUMMARY OF INVENTION

### Technical Problem

However, there are a plurality of types of antennas (expensive omnidirectional antenna, inexpensive directional antenna, and the like) that can be used for a 5G base station, and there are a plurality of types of devices (devices having high power but low directivity, low power but high directivity, and the like) for Wi-Fi base stations. Therefore, there is an issue that it is not possible to perform appropriate radio zone design simply by considering an installation position and an installation orientation as in the conventional art.

The present invention has been made in view of the above points, and an object thereof is to appropriately design installation of a base station for wireless communication.

### Solution to Problem

In order to solve the above issue, an invention according to claim 1 is a radio zone design apparatus that performs designing related to installation of a base station for wireless communication within a radio zone design target area, the radio zone design apparatus including: a radio wave propagation estimation unit that, by performing radio wave propagation estimation for each evaluation position where a radio wave can be received from each base station related to each combination of an antenna of a predetermined type or an access point device of a predetermined type in a case where installation is performed at a predetermined installation position candidate in a predetermined installation orientation by radio wave propagation estimation, calculates an estimated reception power at each evaluation position for each combination; a quality evaluation index calculation unit that calculates a quality evaluation index indicating a ratio of a number of predetermined evaluation positions where a target reception power is achieved to a number of all evaluation positions in each combination using the estimated reception power; a cost evaluation index calculation unit that calculates a cost evaluation index in each combination on a basis of cost information of each base station; a comprehensive evaluation index calculation unit that calculates a comprehensive evaluation index in each combination on a basis of the quality evaluation index and the cost evaluation index; and a selection unit that selects, from each combination, a combination that is single in which a comprehensive evaluation index having a maximum value is calculated or a plurality of the combinations in which a predetermined number of sample comprehensive evaluation indexes having top values are calculated.

### Advantageous Effects of Invention

As described above, according to the present invention, it is possible to appropriately design installation of a base station for wireless communication.

### BRIEF DESCRIPTION OF DRAWINGS

FIG. 1 is an overall configuration diagram of a communication system according to the present embodiment.

FIG. 2 is an electrical hardware configuration diagram of a radio zone design apparatus according to the present embodiment.

FIG. 3 is an electrical hardware configuration diagram of a communication terminal according to the present embodiment.

FIG. 4 is a functional configuration diagram of a radio zone design apparatus according to a first embodiment.

FIG. 5 is a conceptual diagram of a radio zone design target area.

FIG. 6 is a flowchart illustrating a radio zone design method executed by the radio zone design apparatus according to the first embodiment.

FIG. 7 is a flowchart illustrating the radio zone design method executed by the radio zone design apparatus according to the first embodiment.

FIG. 8 is a diagram illustrating each index calculated for each installation position candidate, installation orientation, and 5G antenna type (or device type of a Wi-Fi access point).

FIG. 9 is a functional configuration diagram of a radio zone design apparatus according to a second embodiment.

FIG. 10 is a flowchart illustrating a radio zone design method executed by the radio zone design apparatus according to the second embodiment.

FIG. 11 is a flowchart illustrating a radio zone design method executed by the radio zone design apparatus according to the second embodiment.

FIG. 12 is a diagram illustrating each estimated reception power calculated and an input cost for each combination of an installation position candidate, an installation orientation, and a 5G antenna type (or a Wi-Fi access point type).

### DESCRIPTION OF EMBODIMENTS

Hereinafter, an embodiment of the present invention will be described with reference to the drawings.

### System Configuration of Embodiment

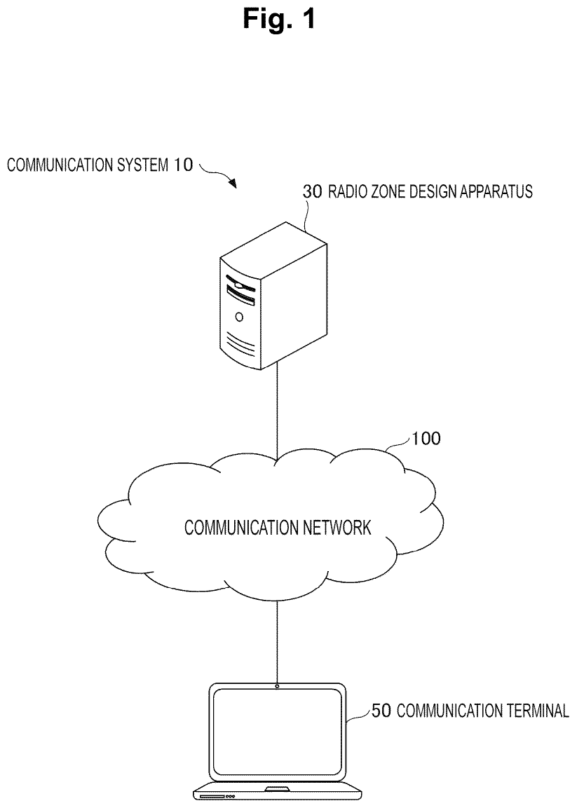

First, an overall configuration of a communication system according to the present embodiment will be described with reference to FIG. 1. FIG. 1 is an overall configuration diagram of the communication system according to the present embodiment.

As illustrated in FIG. 1, a communication system 10 in the present embodiment is constructed by a radio zone design apparatus 30 and a communication terminal 50. The communication terminal 50 is managed and used by a user. The user is a person who determines a subsequent response with reference to an output result of the radio zone design apparatus 30.

The radio zone design apparatus 30 and the communication terminal 50 can communicate with each other via a communication network 100 such as the Internet. A connection form of the communication network 100 may be either wireless or wired.

The radio zone design apparatus 30 includes one or a plurality of computers. In a case where the radio zone design apparatus 30 includes a plurality of computers, the radio zone design apparatus 30 may be referred to as a “radio zone design apparatus” or a “radio zone design system”. The radio zone design apparatus 30 is a device that performs design related to installation of a base station for wireless communication, and performs more appropriate radio zone design in consideration of not only an installation position and an installation orientation of a base station for wireless communication but also the device cost and the 5G antenna type (or type of a Wi-Fi access point (AP) device).

The communication terminal 50 is a computer, and FIG. 1 illustrates a laptop personal computer as an example. In FIG. 1, the user operates the communication terminal 50. Note that the radio zone design apparatus 30 may independently perform processing without using the communication terminal 50.

### Hardware Configuration

### <Hardware Configuration of Radio Zone Design Apparatus>

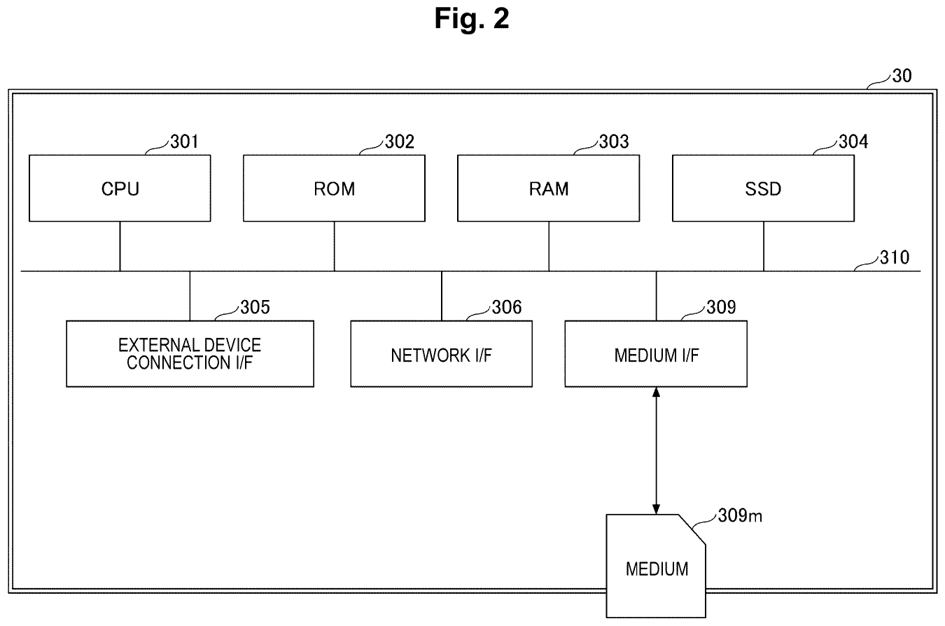

Next, an electrical hardware configuration of the radio zone design apparatus 30 will be described with reference to FIG. 2. FIG. 2 is an electrical hardware configuration diagram of the radio zone design apparatus.

As illustrated in FIG. 2, the radio zone design apparatus 30 includes, as a computer, a central processing unit (CPU) 301 serving as a processor, a read only memory (ROM) 302, a random access memory (RAM) 303, a solid state drive (SSD) 304, an external device connection interface (I/F) 305, a network I/F 306, a medium I/F 309, and a bus line 310.

Among those units, the CPU 301 controls overall operation of the radio zone design apparatus 30. The ROM 302 stores a program used for driving the CPU 301, such as an initial program loader (IPL). The RAM 303 is used as a work area of the CPU 301.

The SSD 304 reads or writes various types of data under the control of the CPU 301. Note that a hard disk drive (HDD) may be used instead of the SSD 304.

The external device connection I/F 305 is an interface for connection with various types of external devices. Examples of the external devices in this case include a display, a speaker, a keyboard, a mouse, a universal serial bus (USB) memory, a printer, and the like.

The network I/F 306 is an interface for performing data communication via a communication network 100.

The media I/F 309 controls reading or writing (storing) of data from/to a recording medium 309m such as a flash memory. Examples of the recording medium 309m also include a digital versatile disc (DVD) and a Blu-ray Disc (registered trademark).

The bus line 310 is an address bus, a data bus, or the like for electrical connection with each component such as the CPU 301 illustrated in FIG. 2.

### <Hardware Configuration of Communication Terminal>

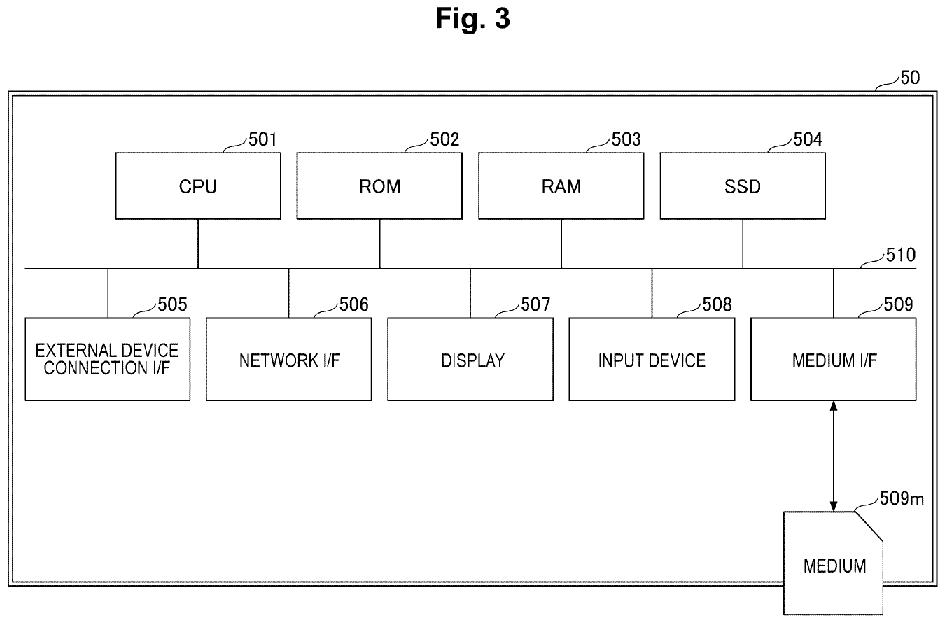

Next, an electrical hardware configuration of the communication terminal 50 will be described with reference to FIG. 3. FIG. 3 is an electrical hardware configuration diagram of the communication terminal.

As illustrated in FIG. 3, the communication terminal 50 includes, as a computer, a CPU 501, a ROM 502, a RAM 503, an SSD 504, an external device connection interface (I/F) 505, a network I/F 506, a display 507, an input device 508, a medium I/F 509, and a bus line 510.

Among those units, the CPU 501 controls overall operation of the communication terminal 50. The ROM 502 stores a program used for driving the CPU 501, such as an IPL. The RAM 503 is used as a work area of the CPU 501.

The SSD 504 reads or writes various types of data under the control of the CPU 501. Note that a hard disk drive (HDD) may be used instead of the SSD 504.

The external device connection I/F 505 is an interface for connection with various types of external devices. Examples of the external devices in this case include a display, a speaker, a keyboard, a mouse, a USB memory, a printer, and the like.

The network I/F 506 is an interface for performing data communication via the communication network 100.

The display 507 is a type of display means such as liquid crystal or organic electro luminescence (EL) that displays various images.

The input device 508 is a keyboard, a pointing device, or the like and is a type of input means that selects and executes various instructions, selects a processing target, and moves a cursor, for example. Note that a function of the pointing device may be turned off in a case where the user uses a keyboard.

The media I/F 509 controls reading or writing (storing) of data from/to a recording medium 509m such as a flash memory. Examples of the recording medium 509m also include a DVD and a Blu-ray Disc (registered trademark).

The bus line 510 is an address bus, a data bus, or the like for electrically connecting each component such as the CPU 501 illustrated in FIG. 3.

### FIRST EMBODIMENT

Next, the radio zone design apparatus 30a will be described as an example of the radio zone design apparatus 30 according to the present embodiment.

### Functional Configuration of First Embodiment

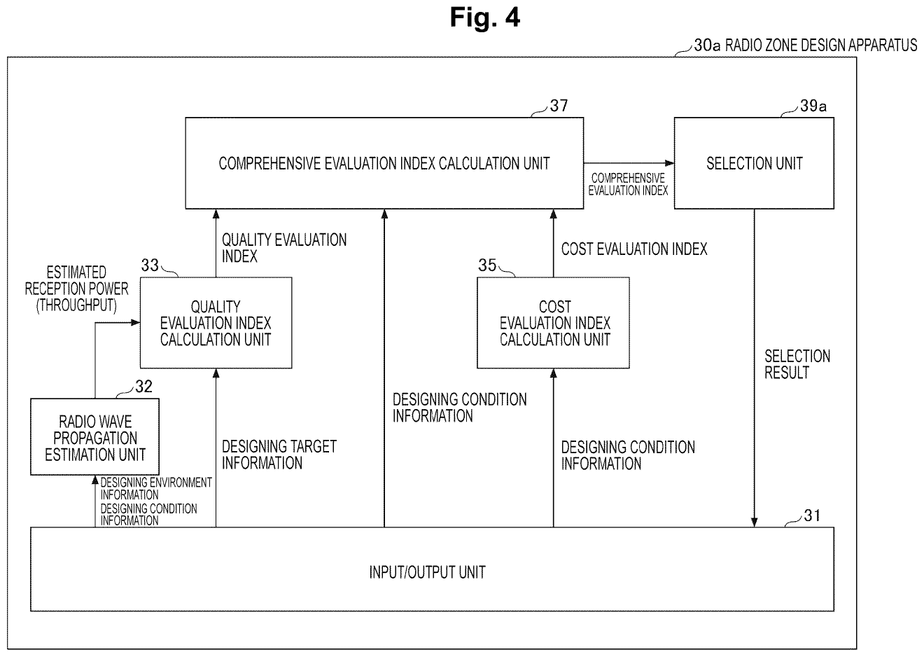

FIG. 4 is a functional configuration diagram of a radio zone design apparatus according to a first embodiment.

As illustrated in FIG. 4, the radio zone design apparatus 30a includes an input/output unit 31, a radio wave propagation estimation unit 32, a quality evaluation index calculation unit 33, a cost evaluation index calculation unit 35, a comprehensive evaluation index calculation unit 37, and a selection unit 39a. Each of those units is a function implemented by a command from the CPU 301 in FIG. 2 on the basis of a program.

The input/output unit 31 inputs designing environment information, designing condition information, and designing target information from the communication terminal 50. Furthermore, the input/output unit 31 outputs a final designing result. Examples of the output include display on a display connected to the radio zone design apparatus 30, printing by a printer or the like connected to the radio zone design apparatus 30, or transmission to the communication terminal 50 via the communication network 100.

The “designing environment information” includes the size of a radio zone design target area, the size and position of a structure, the presence or absence of shielding, information of a 3D map of an area, and the like.

The “designing condition information” includes the type of a 5G antenna (or the type of a device related to Wi-Fi AP), the number of base stations that can be installed (such as the number of stock), a position where a base station can be installed in the radio zone design target area (base station installation position candidate), a radio wave quality evaluation position in the radio zone design target area, information indicating a comprehensive evaluation index calculation formula (coefficient, weighting, case-by-case classification, predetermined value, and the like), and the like.

The “designing target information” includes information indicating a required reception power (or throughput) at an evaluation position disposed in the radio zone design target area.

Note that the information included in the designing environment information, the designing condition information, and the designing target information may be other than the above examples.

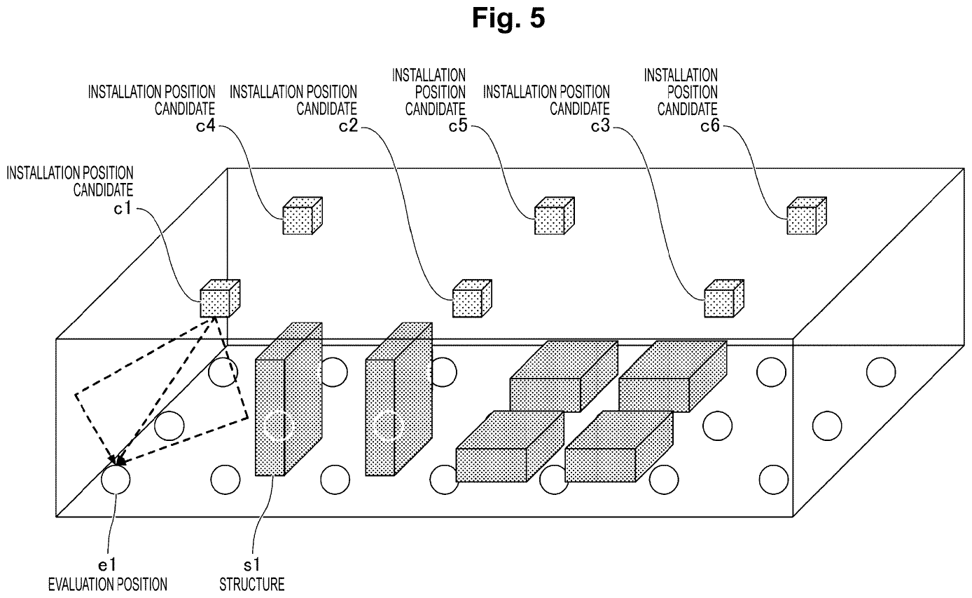

Here, the radio zone design target area will be described with reference to FIG. 5. FIG. 5 is a conceptual diagram of a radio zone design target area. Although an indoor area will be described in FIG. 5, the indoor area may be an outdoor area. As illustrated in FIG. 5, a plurality of installation position candidates c1 to c6 at various places on the ceiling, evaluation positions e1 and the like of radio wave quality at various places on the floor, and structures s1 and the like are set in the radio zone design target area.

Note that the installation position candidates c1 to c6 are collectively referred to as “installation position candidates c”. The evaluation positions e1 and the like are collectively referred to as “evaluation positions e”. The structures s1 and the like are referred to as “structures s”. The numbers of the installation position candidates c, the evaluation positions e, and the structures s illustrated in FIG. 5 are merely examples, and are not limited to the numbers illustrated in FIG. 5.

The radio zone design apparatus 30a of the present embodiment selects one or more optimum installation position candidates c for a 5G base station from a plurality of installation position candidates c. The radio zone design apparatus 30a may select one or more optimum installation position candidates c for a Wi-Fi base station from a plurality of installation position candidates c. By narrowing the radio zone design target area, the radio zone design apparatus 30a can practically select a plurality of optimum installation position candidates c. Note that these (selecting one optimum installation position candidate c for a 5G base station, selecting one optimum installation position candidate c for a Wi-Fi base station, and practically selecting a plurality of optimum installation position candidates c) similarly apply to the following radio zone design apparatus 30b.

Next, referring back to FIG. 4, the radio wave propagation estimation unit 32 calculates an estimated reception power (or throughput) by performing radio wave propagation estimation (simulation) such as ray tracing using a 3D model. Specifically, the radio wave propagation estimation unit 32, by performing radio wave propagation estimation for each evaluation position where a 5G radio wave can be received from each base station related to each combination of a 5G antenna of a predetermined type in a case where installation is performed at a predetermined installation position candidate in a predetermined installation orientation on the basis of the designing environment information and the designing condition information, calculates an estimated reception power (or throughput) at each evaluation position for each combination. Alternatively, the radio wave propagation estimation unit 32, by performing radio wave propagation estimation for each evaluation position where a Wi-Fi radio wave can be received from a base station related to each combination of an AP device of a predetermined type in a case where installation is performed at a predetermined installation position candidate in a predetermined installation orientation on the basis of the designing environment information and the designing condition information, calculates an estimated reception power (or throughput) at each evaluation position for each combination. For example, in a case where the number of ceiling installation position candidates is six, the installation orientations are four, the number of 5G antenna types is two, and the number of the floor evaluation positions is 10, the radio wave propagation estimation unit 32 performs calculation 480 times (=6*4*2*10). In a case where the number of ceiling installation position candidates is six, the installation orientations are four, the number of AP device types is three, and the number of the floor evaluation positions is 10, the radio wave propagation estimation unit 32 performs calculation 720 times (=6*4*3*10).

Note that in a case where the radio wave propagation estimation unit 32 calculates the throughput, for example, the throughput may be predicted from a conversion table of reception powers and throughputs prepared in advance by acquisition of experimental data or link level simulation.

The quality evaluation index calculation unit 33, using the estimated reception power calculated by the radio wave propagation estimation unit 32, calculates a quality evaluation index indicating a ratio of the number of predetermined evaluation positions where a target reception power in designing target information is achieved to the number of all evaluation positions in each combination of an antenna of a predetermined type in a case where installation is performed at a predetermined installation position candidate in a predetermined installation orientation. For example, in a case where there are four evaluation positions e1, e2, e3, and e4, and there are three evaluation positions e1, e2, and e3 that have reached (achieved) the target reception power when a radio wave is output from a base station of a predetermined combination, the quality evaluation index related to the base station of the predetermined combination is 75%.

The quality evaluation index calculation unit 33, using the estimated reception power calculated by the radio wave propagation estimation unit 32, may calculate an achievement rate with respect to the target reception power at each evaluation position and calculate a quality evaluation index indicating the average of the achievement rate at each evaluation position in each combination of an antenna of a predetermined type in a case where installation is performed at a predetermined installation position candidate in a predetermined installation orientation. For example, in a case where there are three evaluation positions e1, e2, and e3 and when a radio wave is output from a base station of a predetermined combination, 110% with respect to the target reception power is achieved at the evaluation position e1, only 90% with respect to the target reception power is achieved at the evaluation position e2, and only 70% with respect to the target reception power is achieved at the evaluation position e3, the quality evaluation index related to the base station of the predetermined combination is 90% (=(110+90+70)/3).

Note that the target reception power (or throughput) is set in advance for each evaluation position.

The cost evaluation index calculation unit 35 calculates a cost evaluation index in each combination (antenna of a predetermined type (or AP device of a predetermined type) in a case where installation is performed at a predetermined installation position candidate in a predetermined installation orientation) on the basis of cost information of each base station in the designing condition information using, for example, the following (Formula 1). A and B are predetermined values included in the designing condition information.

Cost evaluation index=(A−device cost)*B (Formula 1)

The comprehensive evaluation index calculation unit 37 calculates a comprehensive evaluation index in each combination (antenna of a predetermined type in a case where installation is performed at a predetermined installation position candidate in a predetermined installation orientation) by multiplying the quality evaluation index and the cost evaluation index by corresponding coefficients (α, β) in the designing condition information. The comprehensive evaluation index calculation unit 37 calculates the comprehensive evaluation index using, for example, the following (Formula 2).

Comprehensive evaluation index=α*target reception power achievement rate+β*cost evaluation index (Formula 2)

Note that the comprehensive evaluation index calculation unit 37 may first narrow down the quality evaluation index to the quality evaluation index of a predetermined value or more, and calculate a comprehensive evaluation index on the basis of a quality standardized index corresponding to the quality evaluation index after the narrowing down and the cost evaluation index.

The selection unit 39a selects a combination (combination of an installation position candidate, an installation orientation, and a 5G antenna type (or Wi-Fi access point type)) related to the comprehensive evaluation index having the maximum value (or N (predetermined number) comprehensive evaluation indexes having top values) and outputs a selection result.

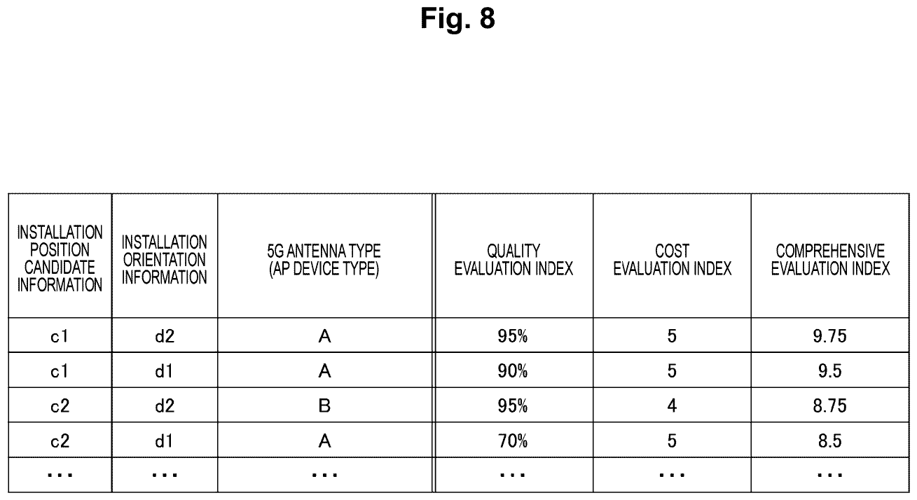

FIG. 8 is a diagram illustrating each index calculated for each installation position candidate, installation orientation, and 5G antenna type (or device type of a Wi-Fi access point). As illustrated in FIG. 8, in a case where the quality evaluation index calculated by the quality evaluation index calculation unit 33, the cost evaluation index calculated by the cost evaluation index calculation unit 35, and the comprehensive evaluation index calculated by the comprehensive evaluation index calculation unit 37 are listed for each combination of an installation position candidate, an installation orientation, and a 5G antenna type (or AP device type), the selection unit 39a selects a combination related to the comprehensive evaluation index “9.75” having the maximum value (combination of an installation position candidate “c1”, an installation orientation “d2”, and a 5G antenna type “A”) and outputs a selection result. Note that this similarly applies to a case where the radio zone design apparatus 30a handles not the 5G antenna type but the device type of a Wi-Fi access point.

### Processing or Operation in First Embodiment

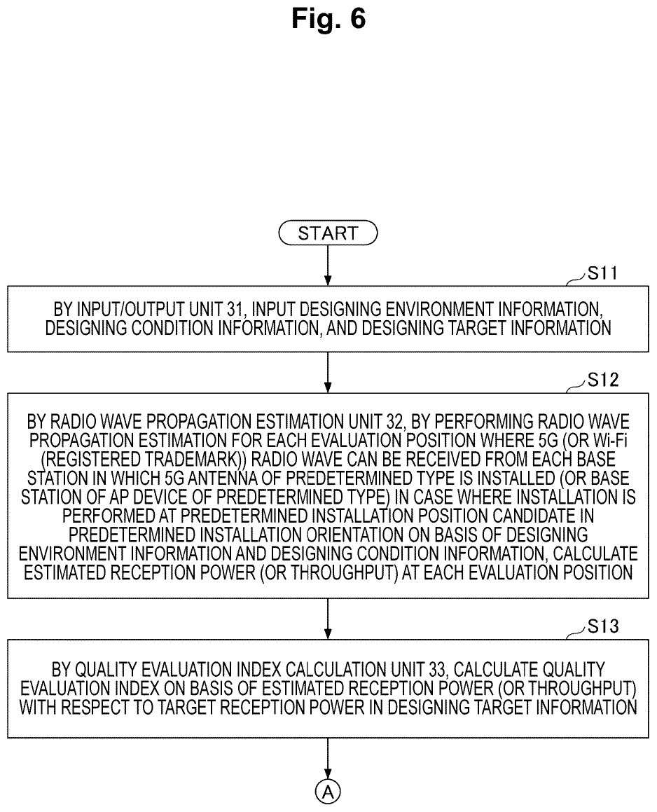

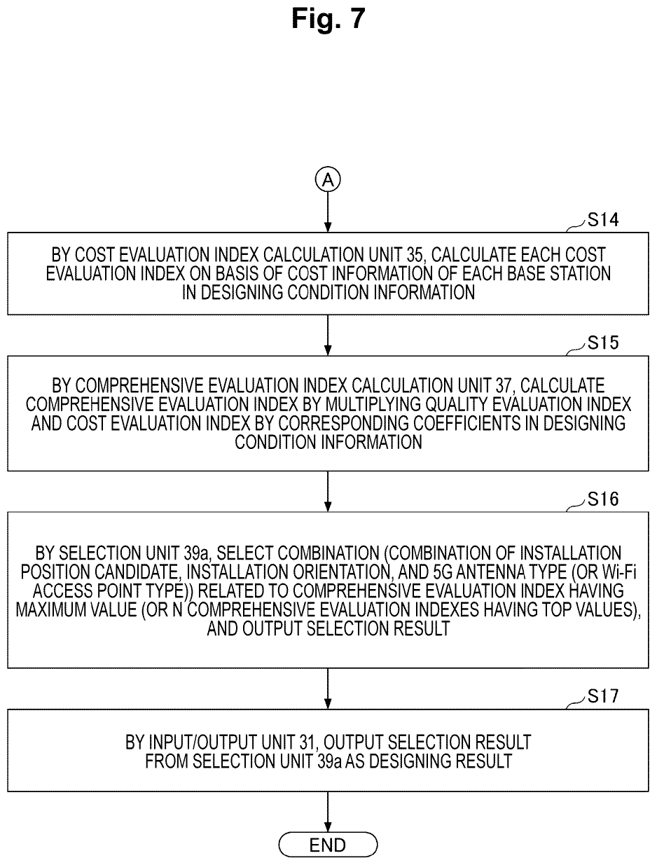

Next, processing or operation of the radio zone design apparatus 30a will be described with reference to FIGS. 6 to 8. FIGS. 6 and 7 are flowcharts illustrating a radio zone design method executed by the radio zone design apparatus according to the first embodiment.
S11: The input/output unit 31 inputs designing environment information, designing condition information, and designing target information from the communication terminal 50 or the like.
S12: The radio wave propagation estimation unit 32, by performing radio wave propagation estimation for each evaluation position where a 5G (or Wi-Fi) radio wave can be received from each base station in which a 5G antenna of a predetermined type is installed (or each base station of an AP device of a predetermined type) in a case where installation is performed at a predetermined installation position candidate in a predetermined installation orientation on the basis of the designing environment information and the designing condition information, calculates an estimated reception power (or throughput) at each evaluation position.
S13: The quality evaluation index calculation unit 33 calculates a quality evaluation index on the basis of the estimated reception power (or throughput) with respect to the target reception power in the designing target information.
S14: The cost evaluation index calculation unit 35 calculates each cost evaluation index on the basis of cost information of each base station in the designing condition information.
S15: The comprehensive evaluation index calculation unit 37 calculates a comprehensive evaluation index by multiplying the quality evaluation index and the cost evaluation index by corresponding coefficients in the designing condition information.
S16: The selection unit 39a selects a combination (combination of an installation position candidate, an installation orientation, and a 5G antenna type (or Wi-Fi access point type)) related to the comprehensive evaluation index having the maximum value (or N comprehensive evaluation indexes having top values) and outputs a selection result.
S17: The input/output unit 31 outputs the selection result from the selection unit 36 as a designing result.

Thus, the description of the processing or operation of the first embodiment ends.

### Effects of First Embodiment

As described above, according to the present embodiment, it is possible to appropriately design installation of a base station for wireless communication.

### SECOND EMBODIMENT

Next, the radio zone design apparatus 30b will be described as an example of the radio zone design apparatus 30 according to the present embodiment.

### Functional Configuration of Second Embodiment

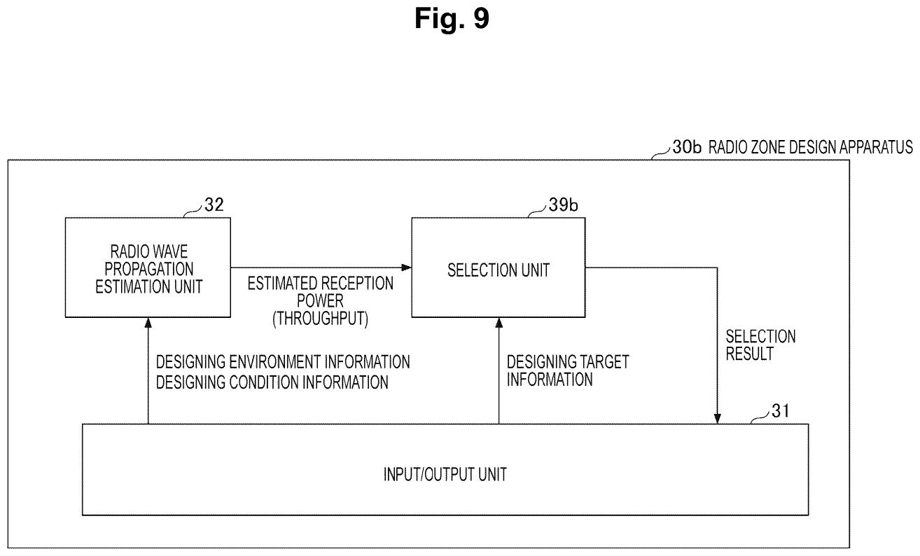

FIG. 9 is a functional configuration diagram of a radio zone design apparatus according to a second embodiment.

As illustrated in FIG. 9, the radio zone design apparatus 30b includes an input/output unit 31, a radio wave propagation estimation unit 32, and a selection unit 39b. Each of those units is a function implemented by a command from the CPU 301 in FIG. 2 on the basis of a program. Note that components similar to those of the first embodiment are denoted by the same reference numerals, and the description thereof will be omitted. In the second embodiment, since the selection unit 39b is different from the selection unit 39a of the first embodiment, the selection unit 39b will be described below.

The selection unit 39b selects n (predetermined number) estimated reception powers (or throughputs) having top values in designing target information. Then, the selection unit 36b determines whether the number of the minimum costs is one. In a case where the number of the minimum costs is one, the selection unit 36b selects a combination (combination of an installation position candidate, an installation orientation, and a 5G antenna type (or AP device type)) related to the minimum cost and outputs a selection result. On the other hand, in a case where the number of the minimum costs is not one (in a case where there is a plurality of minimum costs), the selection unit 36b selects a combination (combination of an installation position candidate, an installation orientation, and a 5G antenna type (or AP device type)) related to an estimated reception power having the maximum value among already selected top n estimated reception powers and outputs a selection result. Note that the selection unit 36b may select a combination (combination of an installation position candidate, an installation orientation, and a 5G antenna type (or AP device type)) related to an estimated throughput having the maximum value among already selected top n estimated throughputs and output a selection result.

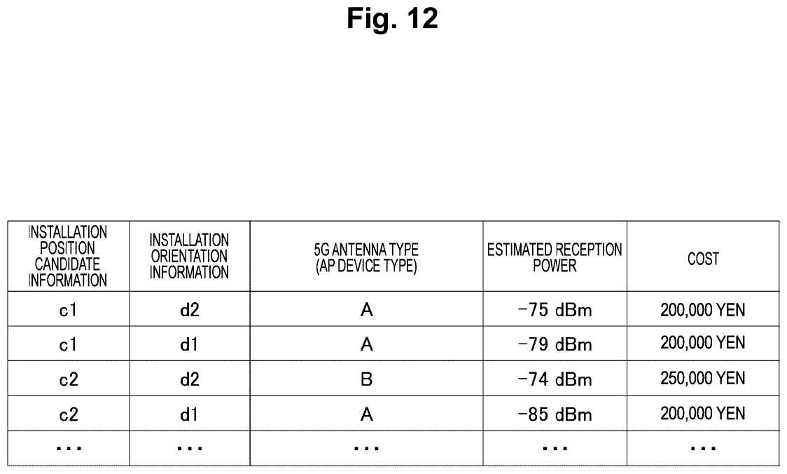

FIG. 12 is a diagram illustrating each estimated reception power calculated and an input cost for each combination of an installation position candidate, an installation orientation, and a 5G antenna type (or a Wi-Fi access point type). For example, as illustrated in FIG. 12, in a case where there are a value of an estimated reception power output from the radio wave propagation estimation unit 32 and a cost value for each combination of an installation position candidate, an installation orientation, and a 5G antenna type (or AP device type), the selection unit 39b selects top n (for example, three) estimated reception powers (or throughputs). As a result, the first, second, and third from the top in FIG. 12 are selected.

Next, in a case where the number of the minimum costs is one, that is selected among the top three, but in FIG. 12, the first and the second from the top in FIG. 12 are the minimum costs among the top three, and thus there are two minimum costs. Therefore, returning to comparison of estimated reception powers, the selection unit 39b compares estimated reception powers of the first and the second from the top in FIG. 12, and finally selects a combination (combination of an installation position candidate, an installation orientation, and a 5G antenna type (or a Wi-Fi AP type)) related to “−75 dBm” that is the estimated reception power having the maximum value.

### Processing or Operation in Second Embodiment

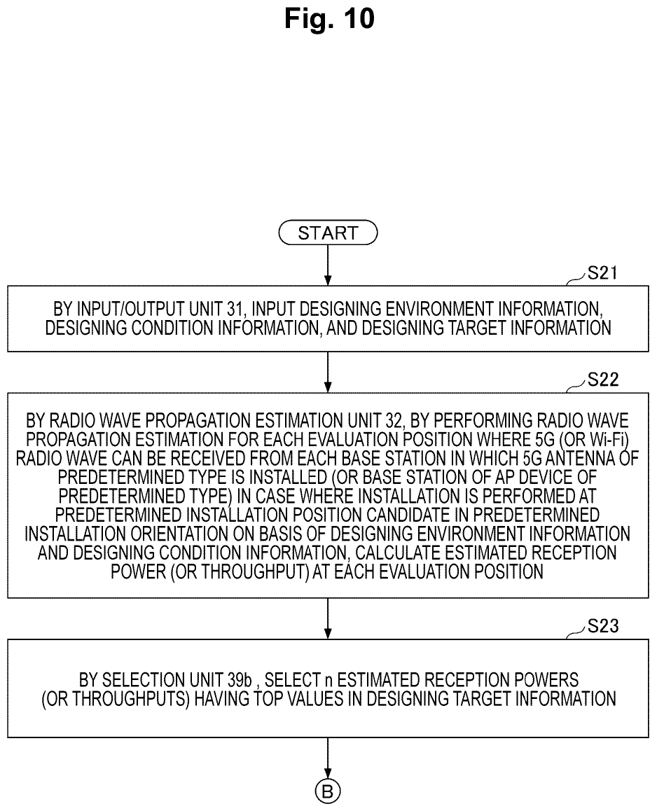

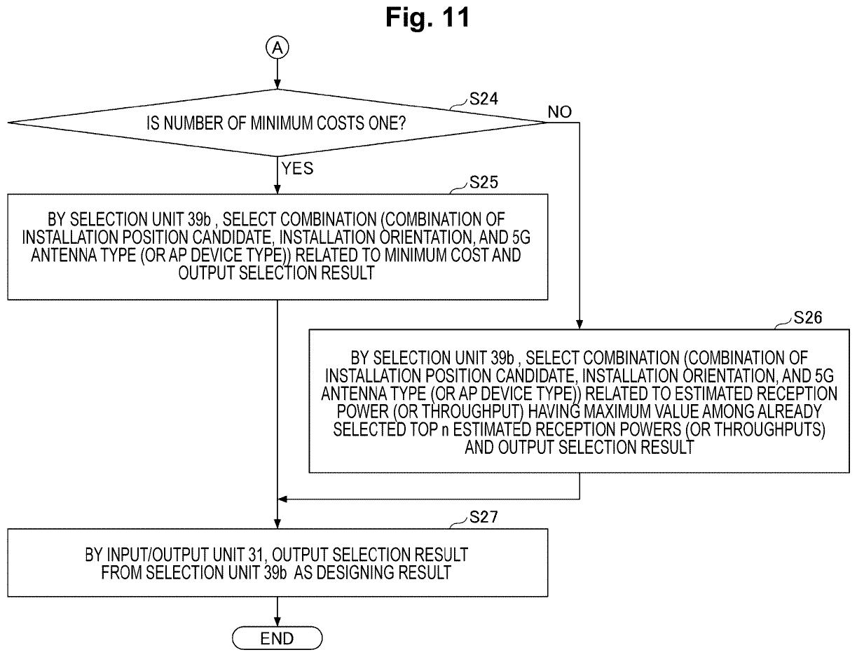

Next, processing or operation of the radio zone design apparatus 30b will be described with reference to FIGS. 10 to 12. FIGS. 10 and 11 are flowcharts illustrating a radio zone design method executed by the radio zone design apparatus according to the second embodiment.
S21: The input/output unit 31 inputs designing environment information, designing condition information, and designing target information from the communication terminal 50 or the like.
S22: The radio wave propagation estimation unit 32, by performing radio wave propagation estimation for each evaluation position where a 5G (or Wi-Fi) radio wave can be received from each base station in which a 5G antenna of a predetermined type is installed (or each base station of an AP device of a predetermined type) in a case where installation is performed at a predetermined installation position candidate in a predetermined installation orientation on the basis of the designing environment information and the designing condition information, calculates an estimated reception power (or throughput) at each evaluation position.
S23: The selection unit 36b selects n estimated reception powers (or throughputs) having top values in designing target information.
S24: The selection unit 36b determines whether the number of the minimum costs is one as a result of selection by the processing of S23.
S25: In a case where the number of the minimum costs is one (S24; YES), the selection unit 36b selects a combination (combination of an installation position candidate, an installation orientation, and a 5G antenna type (or AP device type)) related to the minimum cost and outputs a selection result.
S26: In a case where the number of the minimum costs is not one (in a case where there is a plurality of minimum costs) (S24; NO), the selection unit 36b selects a combination (combination of an installation position candidate, an installation orientation, and a 5G antenna type (or AP device type)) related to an estimated reception power (or throughput) having the maximum value among already selected top n estimated reception powers (or throughputs) and outputs a selection result.
S27: The input/output unit 31 outputs the selection result from the selection unit 36 as a designing result.

Thus, the description of the processing or operation of the second embodiment ends.

### Effects of Second Embodiment

As described above, according to the present embodiment, effects similar to those of the first embodiment are obtained.

Furthermore, since the radio zone design apparatus 30b of the present embodiment does not need to calculate each index as in the first embodiment, it is possible to output a designing result by a relatively simple method.

### Supplementary Notes

The present invention is not limited to the foregoing embodiment and may be configured or processed (operated) as follows.
(1) The radio zone design apparatus 30 can also be implemented by a computer and a program, and the program may be recorded on a (non-transitory) recording medium or be provided via the communication network 100.
(2) Although a laptop personal computer has been described in the above embodiment as an example of the communication terminal 50, the present invention is not limited thereto, and the communication terminal 50 may be, for example, a desktop personal computer, a tablet terminal, a smartphone, a smartwatch, a car navigation device, a refrigerator, or a microwave oven.
(3) Each of the CPUs 301 and 501 may be not only a single CPU but also a plurality of CPUs.
(4) In the above embodiment, the radio wave propagation estimation unit 32 estimates the reception power at each evaluation position e by radio wave propagation estimation (simulation) such as ray tracing using a 3D model, but the present invention is not limited thereto. For example, the radio wave propagation estimation unit 32 may perform actual measurement and prediction of the reception power by calibrating the radio wave propagation estimation result on the basis of actual measurement data at (a part of) each evaluation position.
(5) Furthermore, the radio zone design apparatus may design installation of a station related to a mobile communication system of another generation such as 4G or 6G instead of 5G.

### REFERENCE SIGNS LIST

10 Communication system
30, 30a, 30b Radio zone design apparatus
31 Input/output unit
32 Radio wave propagation estimation unit
33 Quality evaluation index calculation unit
35 Cost evaluation index calculation unit
37 Comprehensive evaluation index calculation unit
39a, 39b Selection unit

1. A radio zone design apparatus that performs designing related to installation of a base station for wireless communication within a radio zone design target area, the radio zone design apparatus comprising:
a processor; and
a memory that includes instructions, which when executed, cause the processor to execute:
performing radio wave propagation estimation for each evaluation position where a radio wave can be received from each base station related to each combination of an antenna of a predetermined type or an access point device of a predetermined type in a case where installation is performed at a predetermined installation position candidate in a predetermined installation orientation by radio wave propagation estimation, to calculate an estimated reception power at each evaluation position for each combination;
calculating a quality evaluation index indicating (i) a ratio of a number of predetermined evaluation positions where a target reception power is achieved to (ii) a number of all evaluation positions in each combination using the estimated reception power;
calculating a cost evaluation index in each combination on a basis of cost information of each base station;
calculating a comprehensive evaluation index in each combination on a basis of the quality evaluation index and the cost evaluation index; and
selecting, from each combination, a combination that is single in which a comprehensive evaluation index having a maximum value is calculated or a plurality of the combinations in which a predetermined number of sample comprehensive evaluation indexes having top values are calculated.

2. The radio zone design apparatus according to claim 1,
wherein the calculating of the quality evaluation index includes calculating an achievement rate with respect to a target reception power at each evaluation position in each combination using the estimated reception power instead of calculating a quality evaluation index indicating a ratio of a number of predetermined evaluation positions where a target reception power is achieved to a number of all evaluation positions in each combination using the estimated reception power, and calculating a quality evaluation index indicating an average of an achievement rate of each evaluation position.

3. The radio zone design apparatus according to claim 1,
wherein the performing of the radio wave propagation estimation includes calculating a throughput at each evaluation position for each combination instead of an estimated reception power at each evaluation position for each combination, and
the calculating of the quality evaluation index includes calculating the quality evaluation index using an estimated reception power corresponding to the throughput.

4. A radio zone design apparatus that performs designing related to installation of a base station for wireless communication within a radio zone design target area, the radio zone design apparatus comprising:
a processor; and
a memory that includes instructions, which when executed, cause the processor to execute:
performing radio wave propagation estimation for each evaluation position where a radio wave can be received from each base station related to each combination of an antenna of a predetermined type or an access point device of a predetermined type in a case where installation is performed at a predetermined installation position candidate in a predetermined installation orientation by radio wave propagation estimation, to calculate an estimated reception power at each evaluation position for each combination; and
selecting a predetermined number of estimated reception powers having top values from an estimated reception power at each evaluation position, and selecting the combination that is specific in having a lowest cost of each combination from the selected predetermined number of estimated reception powers.

5. The radio zone design apparatus according to claim 4,
wherein in a case where there is a plurality of the combinations having a lowest cost of each combination, the selecting includes selecting the combination that is specific in having a highest estimated reception power from the predetermined number of estimated reception powers.

6. The radio zone design apparatus according to claim 4,
wherein the performing of the radio wave propagation estimation includes calculating a throughput at each evaluation position for each combination instead of an estimated reception power at each evaluation position for each combination, and
the selecting includes selecting the combination that is specific using an estimated reception power corresponding to the throughput.

7. A non-transitory computer-readable recording medium having computer-readable instructions stored thereon, which when executed, cause a computer including a memory and a processor to execute a radio zone design method of performing designing related to installation of a base station for wireless communication within a radio zone design target area, the computer being caused to execute:
performing radio wave propagation estimation for each evaluation position where a radio wave can be received from each base station related to each combination of an antenna of a predetermined type or an access point device of a predetermined type in a case where installation is performed at a predetermined installation position candidate in a predetermined installation orientation by radio wave propagation estimation, to calculate an estimated reception power at each evaluation position for each combination;
calculating a quality evaluation index indicating a ratio of a number of predetermined evaluation positions where a target reception power is achieved to a number of all evaluation positions in each combination using the estimated reception power;
calculating a cost evaluation index in each combination on a basis of cost information of each base station;
calculating a comprehensive evaluation index in each combination on a basis of the quality evaluation index and the cost evaluation index; and
selecting, from each combination, the combination that is single in which a comprehensive evaluation index having a maximum value is calculated or a plurality of the combinations in which a predetermined number of sample comprehensive evaluation indexes having top values are calculated.

8. (canceled)
